(19) United States
(12) Patent Application Publication
(10) Pub. No.: US 2005/0259673 A1
(43) Pub. Date: Nov. 24, 2005

(54) Method and system for end-to-end communication between a universal integrated circuit card and a remote entity over an IP-based wireless wide area network and the internet

(75) Inventors: HongQian Karen Lu, Austin, TX (US); Yannick Burianne, Clamart (FR); Vincent Boutet, Montrouge (FR)

Correspondence Address: PEHR JANSSON, ATTORNEY AT LAW, 7628 PARKVIEW CIRCLE, AUSTIN, TX, 78731, US

(73) Assignee: Axalto Inc., Austin, TX (US)

(21) Appl. No.: 10/999,871

(22) Filed: Nov. 30, 2004

Related U.S. Application Data
(60) Provisional application No. 60/572,021, filed on May 18, 2004.

(51) Int. Cl. H04L 12/66

(52) U.S. Cl. 370/419

(57) ABSTRACT

End-to-end communication between a UICC and a remote node on a network without requiring implementation of special purpose protocols at the remote node. The UICC operates to transmit a command using a first protocol from the UICC to the terminal to request the terminal to open a data channel to the network. The wireless terminal operates to, in response to the request to open a data channel, attempt to open a channel to the network. Upon indication that a data channel has successfully been opened: the UICC operates to transmit datagrams of a second protocol to the wireless terminal using the first protocol. The wireless terminal operates to receive the datagrams from the UICC and to transmit the datagrams received from the UICC to the network using the second protocol. The wireless terminal operates to receive datagrams of the second protocol from the remote entity and to transmit the datagrams from the remote entity to the UICC using the first protocol.

### CROSS-REFERENCE TO RELATED APPLICATIONS

This invention claims priority pursuant to 35 USC 119 to provisional application 60/572,021 filed on May 18, 2004.

In co-pending application 10/848,738, titled “SECURE NETWORKING USING A RESOURCE-CONSTRAINED DEVICE”, filed May 19, 2004, assigned to the assignee of the present invention, and the entire disclosure of which is incorporated herein by reference, there is described a system and method for secure communication between a resource-constrained device and a remote entity over a network.

In co-pending application 10/923,374, titled “A METHOD OF SUPPORTING SSL/TLS PROTOCOLS IN A RESOURCE-CONSTRAINED DEVICE”, filed Aug. 20, 2004, assigned to the assignee of the present invention, and the entire disclosure of which is incorporated herein by reference, there is described a system and method for implementing the SSL/TLS protocols on a resource-constrained device.

### TECHNICAL FIELD

The present invention relates generally to communications over a computer network and more particularly to secure and reliable end-to-end communication between an integrated circuit card and a remote entity over an IP-based wireless wide area network and the Internet.

### BACKGROUND OF THE INVENTION

Data communication over the networks used for mobile telephony is becoming increasingly common. Systems initially established for carrying voice conversation are now often used for services that include web surfing on the Internet, communication with a variety of media including data, audio and video. The latest generation wireless wide area networks provide great performance and functionality enhancements that make such services efficient and practical.

In several of the predominant standards for wireless communication, the wireless component, e.g., the mobile telephone, includes an integrated circuit card. Integrated circuit cards are small personal computing devices that are used to protect very sensitive information.

In the case of wireless networks, integrated circuit cards may be installed into a wireless component, known herein as a mobile station, and provides mission critical services such as authentication, authorization and accounting.

The integrated circuit cards used in mobile telephony are referred to by several different acronyms and identifying phrases. A subscriber identification module (SIM) is a smart card used in a communication device. At first, each GSM handset carries a SIM in order to access GSM network. Now many other mobile phones for other networks have SIMs as well. SIMs are also used in TV set-top boxes and PDAs. The SIMs for 3G networks, such as UMTS, are called USIMs (Universal SIM). The SIMs used for CDMA networks are called Removable-User Identity Module (RUIM). These smart cards are security devices. Their primary purposes are authentication, authorization, and accounting (AAA). They also provide other services such as creation of session keys for encryption, data encryption and decryption, and secure storage for personal information. The user's identity is in the smart card and, hence, physically separated from the handset. This provides security and portability.

The Universal Integrated Circuit Card (UICC) is an application development platform based on 2G platform, 3G platform, or higher platforms. The SIM, USIM, and RUIM are examples of Network Access Applications (NAA) built on top of the UICC. For convenience, in the rest of this document, we may use the terms UICC, (U)SIM, and smart card interchangeably to represent any UICC in a mobile device, where the UICC supports at least one NAA.

The functions such as authentication, authorization, and accounting provided by an integrated circuit card may be provided to allow a user to access services located on a remote entity on the Internet. While very important and sensitive information and services are provided by the integrated circuit card the security of that information is somewhat compromised when it is transmitted via the mobile station and the wireless wide area network without end-to-end security. To provide end-to-end security using standard Internet security protocols such as SSL and TLS requires a reliable end-to-end communications scheme from the integrated circuit card to the remote entity.

It is therefore desirable to provide a system and method for reliable end-to-end communication between an integrated card, e.g., a UICC, and the remote entity. Such end-to-end communication should be provided with minimal intervention of the wireless terminal and allow the integrated circuit card to act as a node on the network.

One international standards collaboration project for wireless wide area networks, the 3^{rd} Generation Partnership Project (3GPP), introduced a protocol, CAT_TP, to address the issue of end-to-end security between an integrated circuit card used in a wireless mobile station and a remote entity. CAT_TP provides a reliable and full-duplex communication channel between an integrated circuit card and a remote entity. CAT_TP is an additional transport layer located on top of the standard Internet transport protocol (UDP/TCP). To communication between the integrated circuit card and the remote entity using CAT_TP, a client executing on the remote entity implements the CAT_TP protocol. CAT_TP is described in ETSI TS 102 124: “Smart Cards: Transport Protocol for UICC Based Applications, Stage 1”, V 6.0.0 (2003-2) and ETSI TS 102 127: “Smart Cards: Transport Protocol for UICC Based Applications, Stage 2”, V 6.0.0 (2004-1).

This solution is undesirable for at least two reasons. First, it increases the overhead associated with data communication because it adds an additional transport layer, the CAT_TP layer. Second, it imposes a requirement on all remote entities, namely, to add the CAT_TP layer, which is not an Internet standard layer, on top of existing communications layers, such as TCP or UDP. Thus, such remote entities are required to treat wireless clients differently from non-wireless clients.

From the foregoing it will be apparent that there is still a need for an improved method to provide support for cryptographic communications protocols such as SSL/TLS on resource-constrained devices so as to enable secure communications end-to-end between the UICC device and the remote node.

### SUMMARY OF THE INVENTION

In a preferred embodiment, the invention provides a system and a method for providing reliable end-to-end communication between a UICC and a remote node on a network without requiring implementation of special purpose protocols at the remote node. The UICC operates to transmit a command using a first protocol from the UICC to the terminal to request the terminal to open a data channel to the network. The wireless terminal operates to, in response to the request to open a data channel, attempt to open a channel to the network. Upon indication that a data channel has successfully been opened: the UICC operates to transmit datagrams of a second protocol to the wireless terminal using the first protocol. The wireless terminal operates to receive the datagrams from the UICC and to transmit the datagrams received from the UICC to the network using the second protocol. The wireless terminal operates to receive datagrams of the second protocol from the remote entity and to transmit the datagrams from the remote entity to the UICC using the first protocol. In an embodiment of the invention, the first protocol is Bearer Independent Protocol and it provides a mechanism to enable the UICC to request a terminal to manage a data channel to the network wherein to manage includes executing at least one function selected from the set including open channel, close channel, send data on the channel, and receive data on the channel. The second protocol may be, for example, the Internet Protocol (IP).

In an embodiment the UICC communicates in a reliable manner to the remote entity over the data channel using the second protocol to transmit a packet of a third protocol wherein the third protocol provides mechanisms for reliable communication. The third protocol may, for example, be the Transmission Control Protocol (TCP).

The UICC may further be assigned an IP address according to a method selected from pre-assigning the IP address to the UICC, or transmitting from the UICC to the wireless terminal an indication that the UICC does not have an IP address and operating the wireless terminal to assign the UICC with an IP address according to a method selected from obtaining a new IP address from the network and assigning the new IP address to the UICC, assigning the UICC a default address, and assigning the UICC a private address.

In an embodiment of the invention, the wireless terminal routes the datagrams using an IP routing capability to transmit the datagrams received from the UICC to a destination and to transmit the datagrams from the remote entity to the UICC.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the operating environment in which a UICC device according to the invention may be used to provide reliable communication with a remote entity.

FIG. 2 is a schematic illustration of an exemplary architecture of the hardware of a UICC that may be used in conjunction with the invention.

FIG. 3 is a schematic illustration of the protocol stack configuration in GPRS network, as an example.

FIG. 4 is a schematic illustration of the protocol stacks of the three entities, the UICC 101, the mobile station 103 and a remote entity 127, according to a first embodiment of the invention.

FIG. 5 is a schematic illustration showing the architecture and communications protocols using the Bearer Independent Protocol (BIP) as the link layer illustrated in FIG. 4 between the UICC and the wireless mobile station.

FIG. 6 is a schematic illustration illustrating an alternative use of the communications architecture according to the invention and presented in FIG. 5.

FIG. 7 is a timing sequence diagram illustrating the interaction between three nodes, namely, the UICC according to the invention, a mobile station and an Internet gateway in the network for allowing the UICC according to the invention to communicate reliably end-to-end to the remote entity.

FIGS. 8 through 10 are schematic illustrations of various routing scenarios illustrating how the mobile station routes datagrams that it receives either from a mobile station or the network.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

1.0 Introduction

As shown in the drawings for purposes of illustration, the invention is embodied in a novel integrated circuit card for use with mobile terminals, e.g. Universal Integrated Circuit Cards, and software for such a card for reliable communications with remote nodes over a computer network. A UICC implemented according to the invention provides reliable end-to-end communication with a remote node on the Internet without imposing additional overhead associated with the introduction of communications layers having the special purpose of providing for such communication. Rather, the UICC according to the invention uses standard communications protocols to provide reliable communication end-to-end with a remote entity on the Internet. There is no additional software or hardware requirements imposed on the remote entity beyond those used to communicate with other nodes on the Internet.

2.0 Design Overview

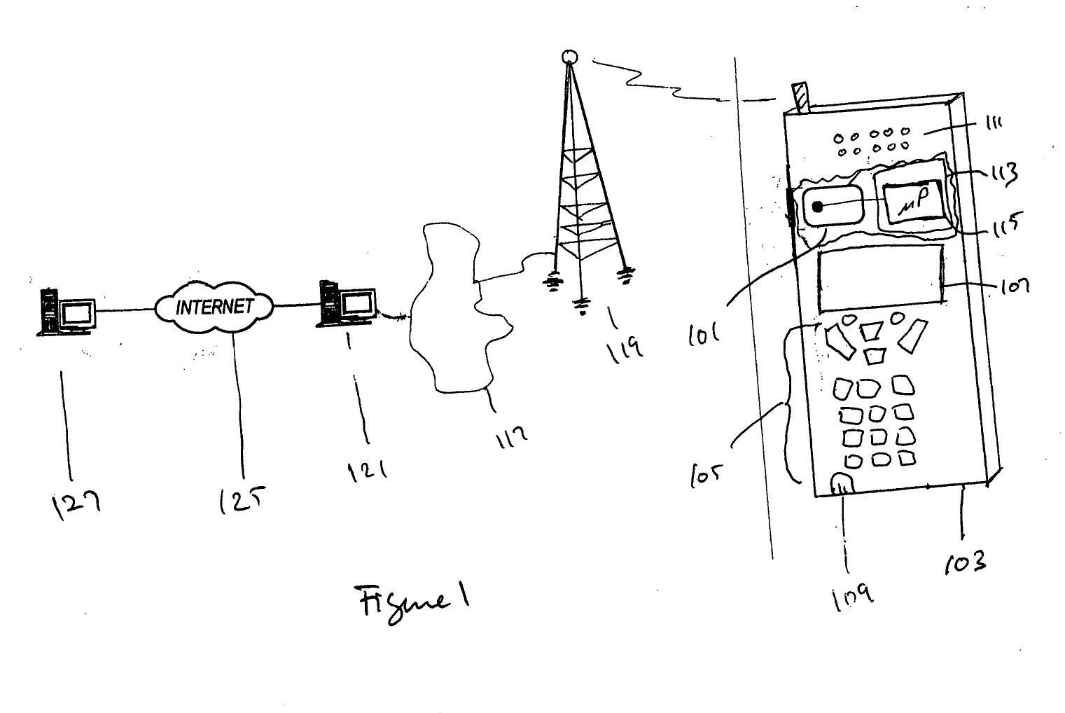

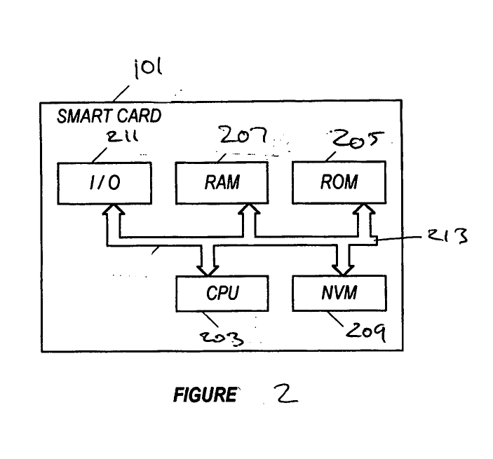

FIG. 1 is a schematic illustration of the operating environment in which a UICC device according to the invention may be used to provide reliable communication with a remote entity. A UICC 101 is installed into a mobile station 103. The mobile station 103 may be a mobile telephone having the usual accoutrements of a mobile telephone such as a keypad 105, a display 107, a microphone 109 and a speaker 111. The mobile station 103 also contains a electronic circuitry 113 including a microprocessor 115.

The electronic circuitry 113 provides communications functionality for the mobile station 103 with a wireless network 117 via a wireless link to a wireless telephony antenna 119. And the microprocessor provides some of the control functionality of the mobile station 103, such as managing operations of the mobile station 103 and managing communications protocols used to communicate with the wireless network 117. The UICC 101 is connected to the electronic circuitry 113 so as to allow communication between the UICC 101 and the mobile station 103.

The wireless network 117 is composed of a complex communications infrastructure for providing connections to other stations, for example, other mobile stations or land-based telephone systems. One such station may be an Internet gateway 121 which gives the wireless network 117 access to the Internet. As commonly known, very many computers are connected via the Internet. In the scenario presented herein, the user of a mobile station uses the infrastructure illustrated in FIG. 1 to communicate with a remote entity 127 connected to the Internet 125. Some aspect of this communication uses direct communication between the UICC 101 and the remote entity 127, for example, for the purpose of communicating some information that is stored on the UICC 101 to the remote entity 127.

The UICC 101 is a smart card having a central processing unit 203, a read-only memory (ROM) 205, a random access memory (RAM) 207, a non-volatile memory (NVM) 209, and a communications interface 211 for receiving input and placing output to a mobile station 103, particularly the electronics 113 of the mobile station 103, to which the UICC device 101 is connected. These various components are connected to one another, for example, by bus 213. In one embodiment of the invention, the communications module 405 (described herein below), as well as other software modules described herein below, would be stored on the resource-constrained device 101 in the ROM 205. In alternative embodiments, the software modules stored in ROM 205 would be stored in a flash memory or other types of non-volatile memory. For purposes of illustration, the invention is described using the ROM example. However, that should not be construed as a limitation on the scope of the invention and wherever ROM is used, flash memory and other types of non-volatile memory can be substituted as an alternative.

The ROM 205 would also contain some type of operating system, e.g., a Java Virtual Machine. Alternatively, the communications module 405 would be part of the operating system. During operation, the CPU 203 operates according to instructions in the various software modules stored in the ROM 205.

Thus, according to the invention the CPU 203 operates according to the instructions in the communications module 405 to perform the various operations of the communications module 405 described herein below.

3.0 Wireless Wide Area Networks

The wireless wide area network (WWAN) (also called cellular network) 117 provides national and international wireless communication coverage for voice and data communications. The first generation (1G) wireless networks, constructed in late 70's and early 80's, were analog networks used for voice communications.

The second generation (2G) wireless networks are digital networks. They replaced the 1G networks in 1990's with significant improvements of capacity and voice quality. In addition, the 2G networks provide basic data services, such as simple Internet applications based on Wireless Application Protocol (WAP) and text messaging with Short Message Service (SMS). The 2G networks are circuit-switched networks, which provides very limited data transfer rate. The most popular 2G networks are Global System for Mobile Communications (GSM) networks.

As a step forward to the 3G systems, many operators move to the second-and-a-half-generation wireless networks (2.5G). The 2.5G networks are packet-switched networks that provide packet data services. The data transfer rate (up to 144 Kbps) is nearly 10 times of the 2G networks. The 2.5G networks are often a software upgrade on top of existing 2G systems. Two leading 2.5G network protocols are General Packet Radio Services (GPRS) and Code Division Multiple Access 2000 1×(CDMA 2000 1×).

The third generation (3G) wireless wide area networks will provide further improved network capacity; and high-speed packet data and high quality voice services. The 3G systems are packet-switched digital systems. Many new services, such as high speed Internet access, video streaming and multi-media messaging will come with the realization of 3G networks. (In Europe, 3G systems are often referred to as Universal Mobile-Telecommunication System (UMTS).)

The fourth generation (4G) wireless wide area networks are on the horizon as well. Some telecommunication operators may consider bypassing 3G and going to 4G directly for 4G's offering of higher speed and financial advantages. 4G networks are also packet-switched digital systems.

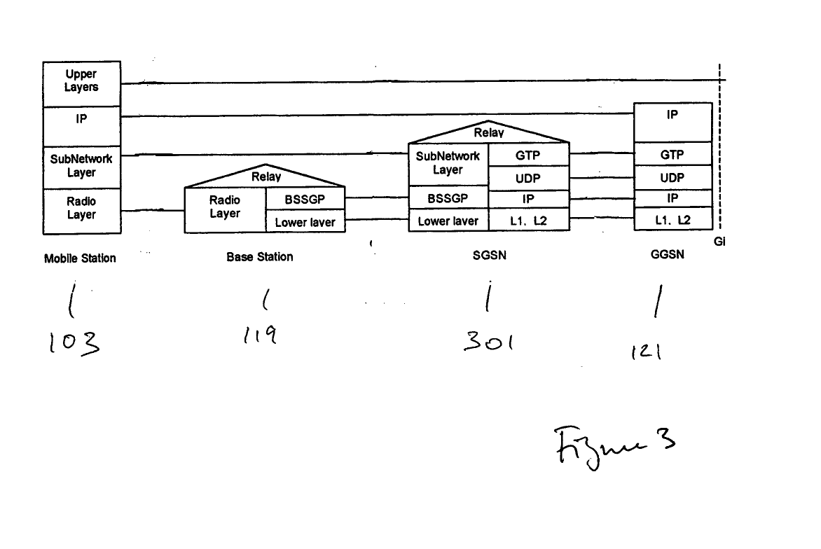

The 2.5G, 3G and 4G networks are IP-based, that is, the communications within the network are based on Internet Protocols (IP). Such IP-based networks can have gateways to the Internet by connecting to other wired or wireless networks. FIG. 3 is a schematic illustration of the protocol stack configuration in GPRS network, as an example.

In FIG. 3, a mobile station (handset) 103 is connected to a GGSN (Gateway GPRS Service Node) 121 which is the gateway to the Internet. This setup enables the mobile station 103 to communicate with a remote server 127 over the Internet 125 through the wireless communication network 117, here a GPRS network.

The mobile station communicates wirelessly to a base station 119 which is connected to a Serving GPRS Support Node (SGSN) 301. The base station 119 and the SGSN 301 provide relay functionality for relaying information transmitted between the mobile station 103 and the gateway 121.

FIG. 3 further illustrates the protocol stacks operating on the various nodes 103, 119, 301, and 121 in a GPRS network. The mobile station 103 implements a radio layer for direct physical link to a corresponding radio layer on the base station 119. For communication with the SGSN 301, the mobile station 103 implements a sub-network communications layer which communicates with a corresponding implementation of a subnetwork layer on the SGSN 301. The mobile station 103 implements the Internet Protocol (IP) for communication with nodes on the Internet 125, including the gateway node 121.

The mobile station 103 may also implement one or more upper communications layers for implementing communication with applications running on remote nodes on the Internet.

The nodes 119, 301, and 121 implement various communications layers for communication at various levels amongst each other. These communication layers are described in greater detail in 3GPP TS 23.060: “Technical Specification Group Services and System Aspects; General Packet Radio Service (GPRS); Service description; Stage 2” V6.1.0 (2003-06), incorporated herein by reference in its entirety.

4.0 UICC-Terminal Interface

The 3GPP's TS 102 221 (ETSI TS 102 221: “Smart cards; UICC-Terminal interface; Physical and logical characteristics”, incorporated herein by reference) specifies that the mobile station 103 communicates to the UICC 101 using the T=0 or T=1 protocols, which are specified in ISO/IEC 7816-3 (ISO/IEC 7816-3 (1997): “Information technology—Identification cards—Integrated circuit(s) cards with contacts—Part 3: Electronic signals and transmission protocols”, incorporated herein by reference). With such protocols, the mobile station 103 always initiates commands to the UICC. The UICC has no mechanism to initiate a communication with the terminal.

FIG. 4 is a schematic illustration of protocol stacks in a system using a network enabled UICC 101 according to the invention with a mobile station 103 to communicate with a remote entity 127. The networked enabled UICC 101 is a smart card with both U(SIM) and network smart card functionality (network smart cards are described in co-pending patent application 10/848,738 to Lu, Hongqian Karen, et al., SECURE NETWORKING USING A RESOURCE-CONSTRAINED DEVICE, Filed May 19, 2004, the entire disclosure of which is incorporated herein by reference).

A network SIM card according to the invention provides reliable communication between the SIM and remote entities via a GPRS network. The approach is applicable to other packet switch wireless WAN as well, such as 3G network. The communication between the SIM and remote entities uses standard Internet TCP/IP protocols and, hence, provide reliable data transmission layer. This enables using standard Internet security protocols such as SSL or TLS to secure the communication channel and, hence, provide end-to-end communication security between SIM and a remote entity.

The architecture according to the invention for realizing this end-to-end secure and reliable communication is described herein in conjunction with FIGS. 4 through 10. In one embodiment, the invention uses the Card Application Toolkit (CAT) and the Bearer Independent Protocol (BIP) to provide and manage the link layer in achieving end-to-end reliable communication between the UICC 101 and the Internet.

Formerly known as SIM Application Toolkit, the Card Application Toolkits (CAT) enables a UICC to interact and to initiate a communication with the terminal through a set of proactive commands. This enables the applications inside the UICC to interact and operate with the terminal, which support the required mechanisms, for example display and user interactions. CAT is described in ETSI TS 102 223: “Smart Cards; Card Application Toolkit (CAT)”, V6.3.0 (2004-01).

CAT is still based on the T=0 and T=1 communication protocols. CAT adds a new status response word SW1. This status response has the same meaning as the normal ending (‘90 00’) and can be used with any command that expect a normal ending. In addition, this new status allows the UICC 101 to tell the mobile station 103 that the UICC 101 wants to send or do something. The mobile station 103 then uses the FETCH function of CAT to find out what action the UICC 101 wants to occur. This exchange enables the UICC 101 to initiate a communication, and to interact and operate with the mobile station 103.

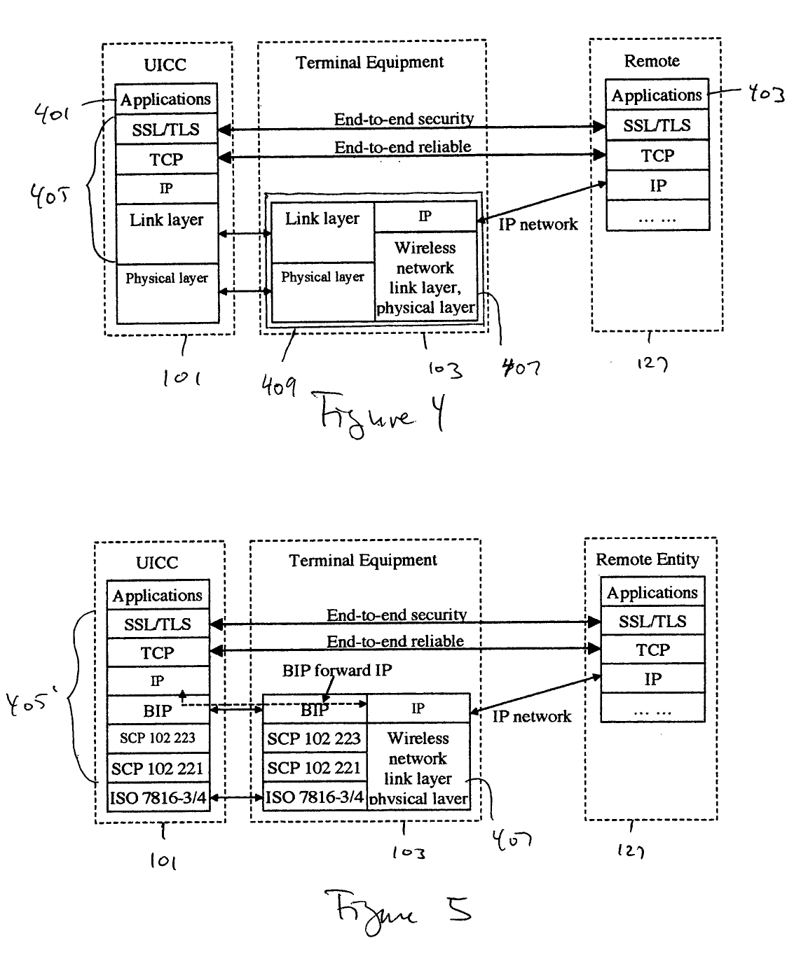

The Bearer Independent Protocol (BIP) is a subset of CAT. BIP is a set of proactive commands {OPEN CHANNEL, CLOSE CHANNEL, SEND DATA, RECEIVE DATA, and GET CHANNEL STATUS} and events {Data available, Channel status}. BIP allows the UICC 101 to establish a data channel with the mobile station 103 to the outside world, e.g., via the Internet. Establishing a BIP data channel enables the UICC 101 to communicate, through the mobile station 103, either to a remote Server in the Internet 125 or to a remote device in the WWAN 117 (as shown in and described in conjunction with FIG. 5 below). To establish a data channel, the UICC 101 provides information for the terminal to select an available bearer. The terminal then allows the UICC and the remote server or device to exchange data through this channel, transparently.

As discussed herein above, one implementation of this architecture uses existing SIM standard Bearer Independent Protocol (BIP) as the link layer to carry IP datagrams. If other physical links, such as USB, are available for SIM in the future, the link layer may be replaced. However, the fundamentals of this architecture and layers above the link layer will remain the same.

5.0 Network Smart Card

5.1 Introduction

A network smart card is a smart card that is an Internet node and is described in greater detail in co-pending patent application Ser. No. 10/848,738. A network smart card has Internet protocols (TCP/IP) and security protocols (SSL/TLS) built into the card. The network smart card can establish and maintain secure Internet connections with another Internet nodes. The card does not dependent on a proxy on the host to enable Internet communications. It does not require local or remote Internet clients or servers to be modified in order to communicate with the smart card either.

Similar to other smart cards, the user information is stored on the network smart card. The smart card only gives out information to the trusted client or server at the user's authorization. The network smart card can be used to secure Internet online transactions and to provide other Internet applications, such as a web server.

5.2 Protocol Stacks

A Network UICC card according to the invention are smart cards with both (U)SIM card and network smart card functionalities. This enables a (U)SIM card to have a end-to-end reliable communication with the remote entity over the Internet. The Internet security protocol, such as SSL or TLS, further secures this reliable communication. The Internet protocol stack forms the upper part of the communication protocol stack. The lower part of the protocol stacks on the UICC 101 and the mobile station 103 depend on the physical and link layers that connect the UICC 101 and the mobile station 103. FIG. 4 illustrates the protocol stacks of the three entities, the UICC 101, the mobile station 103 and a remote entity 127, according to a first embodiment of the invention.

Application programs 401 executing on the network enabled UICC 101 communicates over the network with application programs 403 executing on the remote entity 127.

To enable such communication, the network enabled UICC 101 has a communications module 405 implementing various communications protocols including, for example, SSL/TLS, TCP, IP, and a link layer. Co-pending patent applications 10/923,374 and 10/848,738 describe the implementation of SSL/TLS, TCP and IP on a resource-constrained device such as a smart card. Below these layers is a physical layer 407 for communicating raw-data to the mobile station 103. The actual choices of link layer and physical layer depends on the particular UICC 101 and mobile station 103 and would typically be specified by the mobile station 103.

According to the architecture of the present invention, communications at the applications layer are carried either on SSL/TLS or TCP channels opened from the UICC 101 to the remote entity 127. The communication module 405 accepts data from the applications 401 and encapsulates the data in TCP packets for the TCP layer. The TCP packets are then further encapsulated by the communications module 405 to IP datagrams which the communications module 405 transmits to the mobile station 103 over the link layer.

A GPRS mobile station 103 contains software and hardware modules, e.g., including a communications module 409, with the capability to communicate with the UICC 101 using the link layer protocol established for communication between the UICC 101 and the GPRS mobile station 103. The mobile station 103, further, has software and hardware modules for communication using the Internet Protocol (IP) over the network (the wireless network and the Internet) to a remote entity 127. The mobile station 103 is a conventional wireless terminal, for example, a GSM cellular telephone, that may accept a UICC and is therefore not described in greater detail herein.

The Bearer Independent Protocol (BIP) is one possible link layer for communication between the UICC 101 and the wireless mobile station 103. FIG. 5 is a schematic illustration showing the architecture and communications protocols using BIP as link layer between the UICC 101 and the wireless mobile station 103. In the embodiment of FIG. 5, both the UICC 101 and the mobile station 103 implement BIP in their respective communications modules. The communications module 405′ transmits IP datagrams from the IP layer to the mobile station 103 using BIP frames.

The mobile station 103 communications module communicates with the Internet using IP over the WWAN 117 using the network protocol, link layer and physical protocols 407 specified by the WWAN 117. Thus, the communications module 409 sends the IP datagrams, received from the UICC on the BIP channel between the UICC and the mobile station, to the Internet. These IP datagrams carry the TCP packets end-to-end from the UICC 103 to the remote entity 127. While the mobile station 103 forwards IP datagrams, the mobile station 103 performs no manipulation of the IP datagrams.

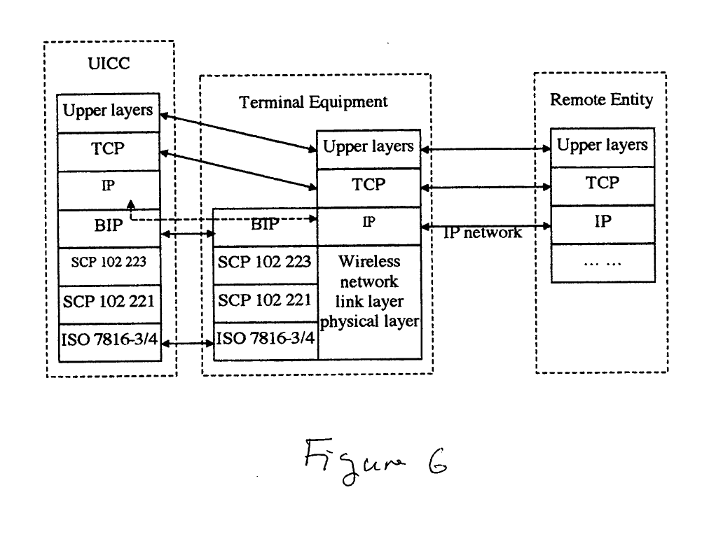

FIG. 6 illustrates an alternative use of the communications architecture according to the invention and presented in FIG. 5. The mobile station 103 can access the UICC 101 the same way as accessing other Internet nodes through Internet protocol. For example, the user of the mobile station 103 can use a web browser on the mobile station 103 to access the UICC 101, which provides the user convenient and familiar human interfaces.

The physical layer for communication between a standard smart card to mobile station are the ISO 7816-3 and 4 protocols. These protocols have the following limitations:
1. the communication is half-duplex;
2. the communication is in command/respond mode;
3. with the typically used 5-bytes header, the data length is limited to 256;
4. the application's intention is expressed in APDU; that is, the application layer and communication layer are mixed together.

In an alternative embodiment of the invention, the link layer is a communications protocol known as Peer I/O described in the co-pending patent application 10/848,738, titled “SECURE NETWORKING USING A RESOURCE-CONSTRAINED DEVICE”, filed May 19, 2004, assigned to the assignee of the present invention, and the entire disclosure of which is incorporated herein by reference. The features of Peer I/O include:
1. support full-duplex communication;
2. enable the smart card to act as a peer on a network;
3. enable application to send and receive data of any length;
4. separate the application layer from the communication layer.

The keys of Peer 10 are two Finite State Machines, one on the card side—the Peer IO client; and the other on the terminal side—the Peer IO server.

For the UICC card, BIP provides some of the Peer IO functionalities, for example the proactive command and regular polling. BIP is a more general communication protocol. The Peer IO is a more efficient communication protocol. For example, for forwarding data from the network to the SIM card, three commands are sent between the terminal and the SIM card as the following:
SIM←ENVELOP(data available)←Terminal
SIM→RECEIVE DATA(data length)→Terminal
SIM←TERMINAL RESPONSE(data)←Terminal

With Peer IO, only the terminal sends one command:
SIM←PUT PACKET (data)←Terminal

In addition, BIP requires the application to call SEND DATA or RECEIVE DATA multiple times in order to send or receive data whose length is longer than 256. Peer IO hides this from the application and separates the application from the communication logic. The present invention does not require a Peer IO implementation. However, the Peer IO is an optimization feature.

6.0 Communications Module on UICC 101

6.1 Overview

FIG. 7 is a timing sequence diagram illustrating the interaction between three nodes in the network for allowing a UICC 101 to communicate reliably end-to-end to a remote entity 127 according to the invention, namely, the UICC 101, the mobile station 103 and the Internet gateway 121.

6.2 Open a Connection

A first sequence 701 illustrates the communication between these three nodes for the establishment of a communications channel between the UICC 101 and the remote entity 127.

The UICC 101 uses a link layer command to direct the mobile station 103 to open a communications channel to the Internet 125. In one embodiment, the UICC 101 uses the BIP layer OPEN CHANNEL command to request the mobile station 103 to open a channel. The parameters for OPEN CHANNEL include the following (ETSI TS 102 223: “Smart Cards; Card Application Toolkit (CAT)”, V6.3.0 (2004-01).):
1. Network Access Name: provides information to the terminal necessary to identify the Gateway entity, which provides interworking with an external packet data network.
2. Local address: provides information to the terminal necessary to identify the local device. If the parameter is present and length is not null, it provides an IP address that identifies the CAT application in the address area applicable to the Packet Data Network (PDN). If local address length is null, dynamic local address allocation is required for the CAT application. If parameter is not present, the terminal may use the terminal default local address configuration.
3. UICC/terminal interface transport level: if present in the command, then the terminal shall provide the requested transport layer protocols under the channel and shall use this object containing a set of parameters required to make the transport connection. The data that is exchanged at the UICC/terminal interface in the RECEIVE DATA/SEND DATA commands are Service Data Units (SDU). When the CAT application sends an SDU, the transport layer within the terminal is in charge to add the transport header to the SDU in order to build the Transport-PDU. When the CAT application requests to receive an SDU, the transport layer within the terminal is in charge to remove the transport header of the Transport-PDU, and to forward the SDU to the CAT. If the parameter is not present, the UICC/terminal interface is the bearer level (serial link or packet link), and the CAT application is in charge of the network and transport layer.
4. Data destination address: it is the end point destination address of sent data. This data destination address is requested when a UICC/terminal interface transport is present, otherwise it is ignored. The data destination address is a data network address (e.g. IP address).
5. Bearer Description: describes bearer.

To open an Internet (IP) channel, the UICC 101 sends OPEN CHANNEL command to the mobile station 103 with parameters include the following, step 703:
1. Network Access Name identifies the Gateway to the IP based packet data network. A network needs only one gateway (GGSN); although it may have more than one gateways for redundancy. The network operator may store the network access name for the gateway in the UICC before issuing the card. When roaming between GSM/GPRS networks, with which the operators have roaming agreements, the terminal and, hence, the UICC can still use the home operator's Network Access Name. The visited network can route the terminal's traffic to its home operator's gateway.
2. Local IP address:
   (a) The length is non zero if the card has an IP address;
   (b) The length is null or the local address is not present: the terminal will assign an IP address dynamically obtained (see Section 4.2 below) or the default IP address.
3. The UICC/Terminal interface transport level parameter is not present. The terminal will forward IP datagrams from/to the UICC to/from the network through BIP.
4. The data destination address is not present because the transport level parameter is not present. The destination address is embedded in the IP datagrams.
5. Bearer Description: may use ‘02’ for the bearer type, which indicate IP packet data service.

The mobile station 103 in turn executes a communications sequence 705 with the gateway 121 to establish the communications channel to the Internet 125. The sequence 705 is specific as to the particular wireless network used, i.e., each wireless operator may have its particular method for establishing a connection to the Internet. The sequence 705 is merely exemplary and is not specific to the present invention.

The mobile station 103 informs the UICC 101 of the success or failure of the open channel using TERMINAL RESPONSE command, step 707. If the channel open is successful, the TERMINAL RESPONSE command includes a Channel Identifier that identifies this channel for subsequent communication; and the terminal has activated the packet data service in behalf of the UICC.

6.3 IP Address for the UICC 101

The UICC 101 needs an IP address in order to communicate over the Internet. The UICC 101 may have a pre-assigned IP address, in which case, the UICC 101 will inform the mobile station 103 in the OPEN CHANNEL command. If the UICC 101 does not have an IP address, it informs the mobile station 103 in the OPEN CHANNEL command. The mobile station 103 can assign the UICC 101 an IP address using one of various methods, such as the following methods:
1. For packet data services, the mobile station 103 explicitly creates data sessions. The session description is called the Packet Data Protocol (PDP) context, which includes information for network type (e.g. IPv4), address, network access name and so on. Most of the time, a mobile station 103 provides an empty IP address in a PDP attach request. This prompts the network to allocate an IP address for the mobile station 103. The mobile station 103 may assign this IP address to the UICC 101. Except special cases, such obtained IP address is behind the Network Address Translation (NAT) gateway of the network.
2. The mobile station 103 may assign the UICC 101 a default address or a private address, for example, 192.96.0.1.

After assigning an IP address to the UICC 101, the mobile station 103 can use one of various methods to send the IP address back to the UICC 101. The following lists a few of such methods:
1. The mobile station 103 uses the link-layer (e.g., BIP) TERMINAL RESPONSE command to send the assigned IP address to the UICC in addition to other information. This is simple and explicit, however, as this is inconsistent with the BIP specification, this method would require a change to the current BIP specification.
2. The mobile station 103 uses the channel identifier and indirectly sends the IP address to the UICC 101. Each BIP channel has a unique channel identifier. When the UICC 101 requests to open a channel with a nil IP address, the mobile station 103 gets an IP address for the UICC 101 as described above, associates the IP address with a unique channel identifier, and sends the channel identifier back to the UICC 101 in the TERMINAL RESPONSE command 707. When the UICC 101 sends the first IP datagram through the opened BIP channel (described herein below in conjunction with sequence 709), it puts a nil IP source address. Because the channel identifier uniquely identifies the BIP channel and the associated IP address, the mobile station 103 can fill up the IP address in the IP datagram according to the channel identifier. The mobile station 103 does this only once for the first IP message from the UICC 101. When an IP datagram comes back to UICC 101 from the mobile station 103, the UICC learns its IP address and starts to use that IP address for the subsequent Internet communications. This method does not require a change to the BIP specification, but requires the mobile station 103 to do more than the first method.
3. The mobile station 103 uses a separate command to send the IP address back to the UICC 101. For example, the mobile station 103 can use an ENVELOP command or a dedicated command.

6.4 IP Routing by Terminal Equipment

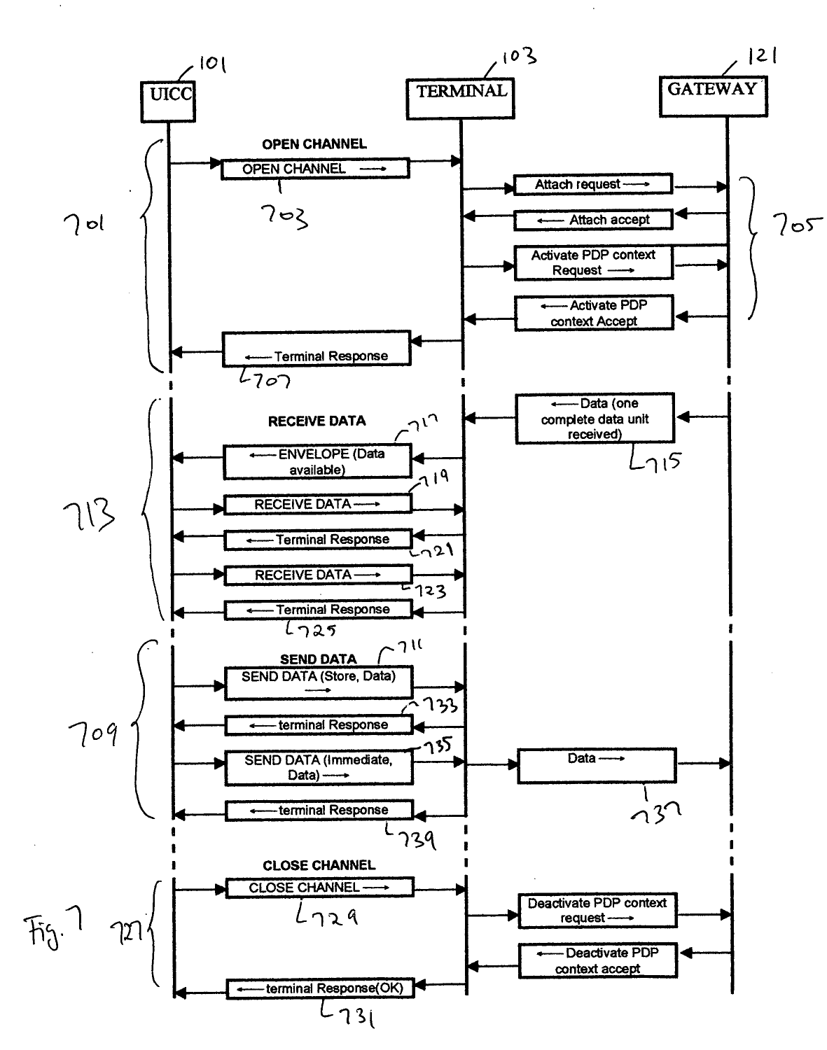

The mobile station 103 equipment's IP layer needs to forward IP datagrams from the UICC 101 to the TCP layer of the mobile station 103 or to the network, and forward to the card the IP datagrams which are generated by the mobile station 103 or received from the network. This requires the mobile station 103 to have the IP routing capability and to treat the module of the mobile station 103 that implements BIP as a network interface. The BIP specification concerning the UICC/Terminal interface transport level implies this routing requirement when the transport level parameter is not present. FIGS. 8 through 10 are schematic illustrations of various routing scenarios.

FIG. 8 is a schematic illustration of a routing scenario wherein a BIP layer module 801 on the mobile station 103 forwards the IP datagrams from the UICC 101. The IP layer module 803 in the mobile station 103 may route the datagrams to the network or to the TCP layer 805 of the mobile station 103, depending on the destination IP address specified in the datagram.

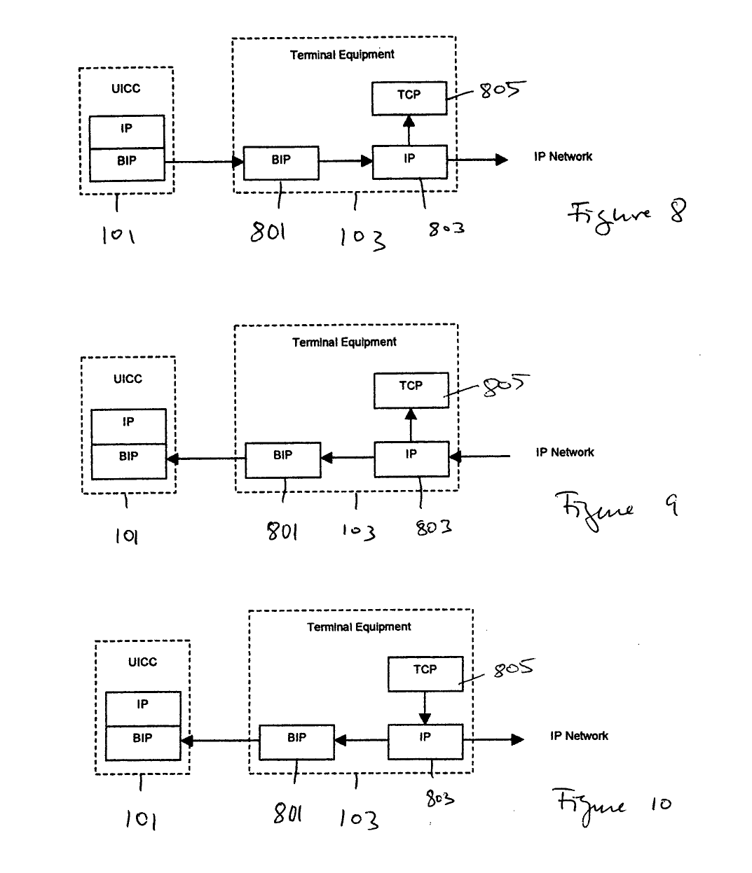

FIG. 9 is a schematic illustration of a routing scenario wherein IP datagrams are received by the mobile station 103 from the network 117. The IP layer in the mobile station 103 may send the datagrams to the TCP layer of the mobile station 103 or to the BIP layer, depending on the destination IP address. If the destination is IP address of the UICC 101, the BIP implementation on the mobile station 103 forwards the IP datagrams to the UICC 101.

FIG. 10 is a schematic illustration of a routing scenario wherein a TCP module in the mobile station 103 sends IP datagrams either to the UICC 101 or to the Internet. The IP layer 803 module in the mobile station 103 may route the datagrams to the network or to the BIP layer module 801 of the mobile station 103, depending on the destination IP address of the data. If the destination is the IP address of the UICC 101, the BIP layer module 801 on the mobile station 103 forwards the IP datagrams to the UICC 101.

Sending a message to a remote entity 127

Returning now to FIG. 7. With IP BIP channel successfully open (sequence 701), the UICC 101 can send messages through the BIP channel to the remote entity 127 over the Internet 125. The CAT command to send data is SEND DATA, with which the UICC 101 requests the mobile station 103 to send data through the data channel set previously and identified by the Channel Identifier (step 711). As described above, the physical layer between the UICC 101 and the mobile station 103 is ISO 7816. ISO-7816 specifies a data transmission format referred to as the Application Protocol Data Unit (APDU) with a data field limited to 256 bytes. Because of the APDU size limitation, the communications module 405 on the UICC 101 might need to send several SEND DATA commands in order to send one message.

The sequence 709 is an example of a sequence wherein the UICC 101 is sending data. The UICC 101 sends a SEND DATA command containing data a parameter “store”, step 711. Upon receiving a SEND DATA command with a “store” parameter, the mobile station 103 may store the data sent in the SEND DATA command in a transmit buffer and transmit the data later so as to optimize the transmission. The mobile station 103 responds with a TERMINAL RESPONSE message, step 733, to report the status of the execution of the SEND DATA command received in step 711. The UICC 101 then sends another SEND DATA command with data and the parameter “immediate”, step 735. The “immediate” parameter indicates to the mobile station 103 to transmit the previously stored data (from step 733) and the data sent in step 735 together and immediately, step 737. The mobile station 103 again responds with a TERMINAL RESPONSE message, step 739, to report status of execution of the previously received SEND DATA command. The illustrated sequence 709 is merely one example of many possible sequences to transmit data over an established data channel. For example, in alternative sequences SEND DATA commands with “store” and “immediate” parameters may be transmitted in an entirely different order or may not even contain both SEND DATA commands with “store” and “immediate” parameters.

To separate applications from the concern of sending and managing multiple SEND DATA commands, Peer 10 client logic (described in the co-pending patent application 10/848,738) may be implemented. Using Peer IO enables an application to send data of any length that the application is capable of. Using Peer IO also separates applications from the communication logic.

Once the IP BIP channel is successfully opened, the UICC 101 can receive messages through the BIP channel from the remote entity 127 over the Internet 125 as illustrated by sequence 713. When the mobile station 103 receives data from the Internet 125 having the UICC 101 as destination, step 715, the mobile station 103 sends an ENVELOP command, step 717, to inform the UICC 101 that data is available for it. The CAT command to receive data is RECEIVE DATA, with which the UICC 101 requests the mobile station 103 to receive data with the requested data length through the data channel set previously and identified by the Channel Identifier from step 707, step 719. In the case of packet/datagram transmission, for example, IP BIP channel, the mobile station 103 will handle one datagram at a time. In the case that the requested data cannot be included in one TERMINAL RESPONSE command because of the APDU size limit, the mobile station 103 informs the UICC 101 of the remaining data length, e.g., step 721. In response, when ready to receive the additional data, the UICC 101 use another RECEIVE DATA to fetch the remaining data, step 723, and the mobile station 103 sends the remaining data in an additional TERMINAL RESPONSE command, step 725.

Note, with Peer IO, the mobile station 103 sends only one command:
SIM←PUT PACKET (data)←Terminal

If the data length exceeds the APDU size limit, more than one {RECEIVE DATA, TERMINAL RESPONSE} command pair in BIP case or more than one PUT PACKET command is required in Peer IO alternative embodiment. However, with Peer IO, this is hidden from the application programs 401.

6.5 Check Channel Status

The UICC 101 uses GET CHANNEL STATUS command to check the status of the communication channel. The mobile station 103 uses TERMINAL RESPONSE to return the requested channel information.

6.6 Close the Connection

Returning to FIG. 7, the UICC 101 uses CLOSE CHANNEL command to request the mobile station 103 to close the channel with a particular Channel Identifier, step 729. The mobile station 103 uses TERMINAL RESPONSE to inform the UICC 101 of the result, step 731.

From the foregoing it will be apparent that the invention provides a novel and advantageous method for providing end-to-end reliable communication from a UICC to a remote note on the Internet without burdening the remote node with the overhead of special protocols for communication with a UICC.

Although specific embodiments of the invention has been described and illustrated, the invention is not to be limited to the specific forms or arrangements of parts so described and illustrated. For example, the invention is applicable to other resource-constrained devices and is applicable to other communications protocols. The invention is limited only by the claims.

1. A method for providing communication between a Universal Integrated Circuit Card (UICC), which is connected to a wireless terminal, and a remote entity on a network, the method comprising:
operating the UICC to transmit a command using a first protocol from the UICC to the terminal to request the terminal to open a data channel to the network;
operating the wireless terminal to, in response to the request to open a data channel, attempt to open a channel to the network;
upon indication that a data channel has successfully been opened:
operating the UICC to transmit datagrams of a second protocol to the wireless terminal using the first protocol;
operating the wireless terminal to receive the datagrams from the UICC and to transmit the datagrams received from the UICC to the network using the second protocol; and
operating the wireless terminal to receive datagrams of the second protocol from the remote entity and to transmit the datagrams from the remote entity to the UICC using the first protocol.

2. The method of claim 1, wherein the first protocol provides a mechanism to enable the UICC to request a terminal to manage a data channel to the network wherein to manage includes executing at least one function selected from the set including open channel, close channel, send data on the channel, and receive data on the channel.

3. The method of claim 2, wherein the first protocol is Bearer Independent Protocol.

4. The method of claim 1, wherein the network has a communications protocol for communication within the network and the second protocol is the communications protocol for communication within the network.

5. The method of claim 4, wherein the second protocol is Internet Protocol (IP).

6. The method of claim 1, further comprising:
operating the UICC to communicate in a reliable manner to the remote entity over the data channel using the second protocol to transmit a packet of a third protocol wherein the third protocol provides mechanisms for reliable communication.

7. The method of claim 6, wherein the third protocol is Transmission Control Protocol (TCP).

8. The method of claim 1, wherein the operating the UICC to transmit a command from the UICC to the terminal to request the terminal to open a data channel to a remote entity on the network comprises identifying a gateway on an IP based packet data network.

9. The method of claim 1, further comprising:
assigning an IP address for the UICC using a method selected from:
pre-assigning the IP address to the UICC,
transmitting from the UICC to the wireless terminal an indication that the UICC does not have an IP address and operating the wireless terminal to assign the UICC with an IP address according to a method selected from obtaining a new IP address from the network and assigning the new IP address to the UICC, assigning the UICC a default address, and assigning the UICC a private address.

10. The method of claim 9, wherein the wireless terminal communicates with the UICC using CAT (Card Application Toolkit) commands and further comprising:
transmitting the IP address of the UICC from the wireless terminal to the UICC using a method selected from:
issuing the CAT TERMINAL RESPONSE command with the IP address,
indirectly sending the address of the UICC by sending the address of the UICC with an IP datagram,
sending the IP address to the UICC in a command especially for that purpose.

11. The method of claim 1 wherein the steps of operating the wireless terminal to transmit the datagrams received from the UICC to a destination and operating the wireless terminal to transmit the datagrams from the remote entity to the UICC comprises routing the datagrams using an IP routing capability.

12. The method of claim 1 wherein UICC and the wireless terminal communicate using the Bearer Independent Protocol (BIP) and wherein the steps of operating the wireless terminal to transmit the datagrams received from the UICC to a destination and operating the wireless terminal to transmit the datagrams from the remote entity to the UICC comprises routing the datagrams using an IP routing capability and treating a module of the wireless terminal to communicate using BIP as a network interface.

13. A method for providing communication between a Universal Integrated Circuit Card (UICC), which is connected to a wireless terminal, and a remote entity on a network, the method comprising:
operating the UICC to transmit a command using a first protocol from the UICC to the terminal to request the terminal to open a data channel to the network;
operating the wireless terminal to, in response to the request to open a data channel, attempt to open a channel to the network;
upon indication that a data channel has successfully been opened:
operating the UICC to transmit datagrams of a second protocol to the wireless terminal using the first protocol;
operating the wireless terminal to receive the datagrams from the UICC and to transmit the datagrams received from the UICC to a destination selected from the set including a module implementing a second communications protocol on the wireless terminal and the network using the second protocol; and
operating the wireless terminal to receive datagrams of the second protocol from the remote entity and to transmit the datagrams from the remote entity to the UICC using the first protocol.

14. The method of claim 13 further comprising:
operating the wireless terminal to receive datagrams from the network and to transmit the datagrams received from the network to a destination selected from the set including a module implementing a second communications protocol on the wireless terminal and the UICC using the second communications protocol.

15. The method of claim 13 wherein the datagram contains a destination IP address and wherein the method further comprises a step of selecting a destination to which to transmit the datagrams received from the UICC selected from the set including a second communications protocol implemented by the wireless terminal and the network further comprising selecting the destination based on the destination IP address of the datagram.

16. A method of reliable communication between a Universal Integrated Circuit Card (UICC) and a remote entity over an IP-based wireless wide area network and the Internet wherein the UICC and the remote entity communicate using Internet protocols; and wherein the UICC has a central processing unit, a random access memory, a non-volatile memory, and a read-only memory, and an input and output component, comprising:
connecting the UICC with the terminal equipment using physical link layer;
connecting the UICC with the terminal equipment using a data link layer;
connecting the terminal equipment with the IP-based wireless wide area network using means of wireless communication;
authenticating the terminal equipment into the wireless networking using the UICC;
connecting the wireless network with the Internet through the gateway of the wireless network; executing on the UICC a communication module implementing Internet protocols operable to communicate with the terminal equipment and operable to communicate with the remote entity over the wireless network and the Internet wherein one of the Internet protocols provides reliable data transmission;
routing the data packets communicated between the UICC and the remote entity using the terminal equipment.

17. The method of claim 16 wherein the data link layer includes the Bearer Independent Protocol.

18. The method of claim 16 wherein the reliable communication channel between the UICC and a remote entity over the IP-based wireless wide area network and the Internet is a secure channel using Internet security protocols.

19. The method of claim 16 wherein at least one application executing on the UICC is an Internet application using the communication module implementing Internet protocols.

20. The method of claim 19 wherein at least one application executing on the terminal equipment is an Internet application communicating with the UICC using Internet protocols.

21. The method of claim 16 wherein at least one program executing on the terminal equipment communicates with the Internet using Internet protocols.

22. The method of claim 16 wherein the terminal equipment is mobile.

23. A Universal Integrated Circuit Card (UICC) capable of reliable communication with a remote entity over an IP-based wireless wide area network and the Internet, comprising:
a central processing unit;
a non-volatile memory connected to the central processing unit;
a read-only memory connected to the central processing unit;
an input/output component connected to the central processing unit for connecting the UICC with a wireless terminal equipment having means to accept Internet protocol packets from the input/output component and to route such packets onto the IP-based wireless wide area network;
wherein the non-volatile memory contains a communications module having instructions for causing the central processing unit to instruct the input/output component to communicate with a remote entity using an Internet protocol capable of providing a reliable data transmission.

24. The UICC of claim 23, wherein the communications module further comprises:
instructions for causing the UICC to communicate an instruction to the terminal equipment requesting the terminal equipment to create a data channel to a remote entity connected on the network.

25. The UICC of claim 24, wherein the communications module further comprises:
instructions for causing the UICC to transmit a datagram with a destination on the network.

26. The UICC of claim 25 wherein the datagram is an IP datagram encoded to be transmitted to the remote entity on the data channel.

27. A Universal Integrated Circuit Card (UICC) having the capability to communicate with a remote entity on a network via a wireless terminal to which the UICC may be connected using the Bearer Independent Protocol, comprising:
a communications module operable to issue commands of a first communications protocol to:
using a BIP OPEN CHANNEL command having parameters including Network Access Name, Local IP address, and Bearer Description to instruct a wireless terminal to establish a data channel to the network;
transmit a datagram to the wireless terminal for delivery to the remote entity via the network wherein a datagram transmitted from the UICC to a remote entity includes a destination address for the datagram corresponding to the remote entity to which it is directed; and
receive a datagram from the remote entity via the network and routed to the UICC by the wireless terminal; and
to transmit datagrams over the data channel using a second protocol to transmit a packet of a third protocol wherein the third protocol provides mechanisms for reliable communication.

28. The UICC of claim 27 wherein the first protocol is the Bearer Independent Protocol.

29. The UICC of claim 27 wherein the second protocol is the Internet Protocol (IP).

30. The UICC of claim 27 wherein the third protocol is the Transmission Control Protocol (TCP).

31. A method of operating a Universal Integrated Circuit Card (UICC) and a wireless terminal to effect secure communication between the UICC and a remote entity connected to the UICC and the wireless terminal over a network, the method comprising:
operating the UICC to request the wireless terminal to open a data channel to the remote entity;
operating the wireless terminal to open a data channel to the remote entity;
operating the wireless terminal to selectively route datagrams from the UICC to the remote entity; and
operating the wireless terminal to selectively route datagrams from the remote entity to the UICC.

32. The method of claim 31 wherein the step of operating the UICC to request the wireless terminal to open a data channel to the remote entity comprises identifying a gateway to an IP based packet data network.

33. The method of claim 31 wherein the UICC communicates with the wireless terminal using the Bearer Independent Protocol.
